(19) United States
(12) Patent Application Publication
(10) Pub. No.: US 2026/0120392 A1
(43) Pub. Date: Apr. 30, 2026

(54) DISPLAY CONTROL DEVICE AND STORAGE MEDIUM

(71) Applicants: DENSO CORPORATION, Kariya-city (JP); TOYOTA JIDOSHA KABUSHIKI KAISHA, Toyota-shi (JP)

(72) Inventors: Kenji KOHARA, Tokyo (JP); Kohei MAEJIMA, Nagakute-shi (JP); Yuki YAMAMOTO, Nagakute-shl (JP)

(21) Appl. No.: 19/431,053

(22) Filed: Dec. 23, 2025

Related U.S. Application Data
(63) Continuation of application No. PCT/JP2024/023953, filed on Jul. 2, 2024.

(30) Foreign Application Priority Data
Jul. 3, 2023 (JP) 2023-109345

(51) Int. Cl. G06T 15/20; B60Q 1/00

(52) U.S. Cl. CPC G06T 15/205; B60Q 1/0076; G06T 2200/24; G06T 2210/62

(57) ABSTRACT

The display control device for a vehicle includes: an interface circuit configured to acquire a viewpoint modification operation by a user for a viewpoint operation device and an imaged image from a camera imaging surrounding of the vehicle, a memory storing a vehicle model that is a three-dimensional model of the vehicle, and an arithmetic calculation circuit. The arithmetic calculation circuit determines the modified viewpoint for the vehicle based on the viewpoint modification operation, generates a bird's-eye view image from the determined modified viewpoint based on the imaged image and a vehicle image, the vehicle image being generated based on the vehicle model, and causes a display to display the generated bird's-eye view image. The arithmetic calculation circuit sets a first transparency level for the portion of the imaged image where the vehicle image overlaps to allow the imaged image to be transparent in the vehicle image in one part, sets a second transparency level which is higher than the first transparency level for the portion where the vehicle image overlaps to allow the imaged image to be transparent in the vehicle image in the other part, and changes, according to the modified viewpoint, range of each of the portion in which the first transparency level is applied and the portion in which the second transparency level is applied in two-dimensional position coordinates of the bird's-eye view image.

### CROSS-REFERENCE TO RELATED APPLICATIONS

The present application is a continuation application of International Application No. PCT/JP2024/023953 filed on Jul. 2, 2024, which claims priority to Japanese Application No. 2023-109345 filed on Jul. 3, 2023. The contents of these applications are incorporated herein by reference in their entirety.

### BACKGROUND

### 1. Technical Field

The present disclosure relates to a display control device and a storage medium.

### 2. Related Art

Conventionally, technologies for displaying a bird's-eye view of a vehicle and its surroundings from a viewpoint to prevent the vehicle from colliding with surrounding people or objects and to assist with lateral movement and passing-by, are described in the following non-patent literature.

“Panoramic View & Side Clearance View/Cornering View,” <URL: https://manual.toyota.jp/toyota/harrier/harrier/2006/vhhv/ja/html/nvch06se020404.html> [accessed May 30, 2023]

### SUMMARY

In the above technology, a viewpoint of the bird's-eye views are fixed for prevention of the vehicle collision, and for assistance with the lateral movement and the passing-by. According to the present inventor's analysis, more flexible adjustment of the bird's-eye view is desirable to enhance occupant convenience. This disclosure aims to provide a technology to perform more flexible adjustment of the bird's-eye view in technology displaying vehicles and their surroundings in a bird's-eye view image.

According to one aspect of the present disclosure, a display control device for a vehicle includes: an interface circuit configured to acquire a viewpoint modification operation by a user for a viewpoint operation device and an imaged image from a camera imaging surrounding of the vehicle, a memory storing a vehicle model that is a three-dimensional model of the vehicle, and an arithmetic calculation circuit. The arithmetic calculation circuit determines the modified viewpoint for the vehicle based on the viewpoint modification operation, generates a bird's-eye view image from the determined modified viewpoint based on the imaged image and a vehicle image, the vehicle image being generated based on the vehicle model, and causes a display to display the generated bird's-eye view image. The arithmetic calculation circuit sets a first transparency level for the portion of the imaged image where the vehicle image overlaps to allow the imaged image to be transparent in the vehicle image in one part, sets a second transparency level which is higher than the first transparency level for the portion where the vehicle image overlaps to allow the imaged image to be transparent in the vehicle image in the other part, and changes, according to the modified viewpoint, range of each of the portion in which the first transparency level is applied and the portion in which the second transparency level is applied in two-dimensional position coordinates of the bird's-eye view image.

By this configuration, it is possible to perform more flexible adjustment of the bird's-eye view in technology displaying vehicles and their surroundings in a bird's-eye view image.

The reference symbols in parentheses attached to each component, etc., indicate one example of the correspondence between that component, etc., and the specific components, etc., described in the embodiments described later.

### BRIEF DESCRIPTION OF THE DRAWING

FIG. 1 is a configuration diagram of a on-board system according to a first embodiment.

FIG. 2 is a flowchart of a process performed by an arithmetic calculation circuit of a vehicle control device.

FIG. 3 is a flowchart showing the process of step S160 in FIG. 2.

FIG. 4 is an example of a bird's-eye view image obtained when a viewpoint is located diagonally upward and to the front right of the vehicle.

FIG. 5 is an example of a bird's-eye view image obtained when the viewpoint is located diagonally upward and to the rear right of the vehicle.

FIG. 6 is an example of a bird's-eye view image obtained when the viewpoint is diagonally upward and to the right of the vehicle.

FIG. 7 is a comparative example of a displayed image when the viewpoint is within a pass-by viewpoint range.

FIG. 8 is an example of a bird's-eye view image when the viewpoint is within the pass-by viewpoint range.

FIG. 9 is a flowchart showing the process of step S170 in FIG. 3.

FIG. 10 is an example of a bird's-eye view image with low process load.

FIG. 11 is an example of a bird's-eye view image when the viewpoint is within the pass-by viewpoint range according to a second embodiment.

FIG. 12 is an example of a bird's-eye view image obtained when the viewpoint is located diagonally upward and to the rear right of the vehicle according to a third embodiment.

FIG. 13 is an example of a bird's-eye view image obtained when the viewpoint is located diagonally upward and to the rear right of the vehicle according to a fourth embodiment.

FIG. 14 is an example of a bird's-eye view image with low processing load according to a fifth embodiment.

### DETAILED DESCRIPTION OF THE PREFERRED EMBODIMENTS

### First Embodiment

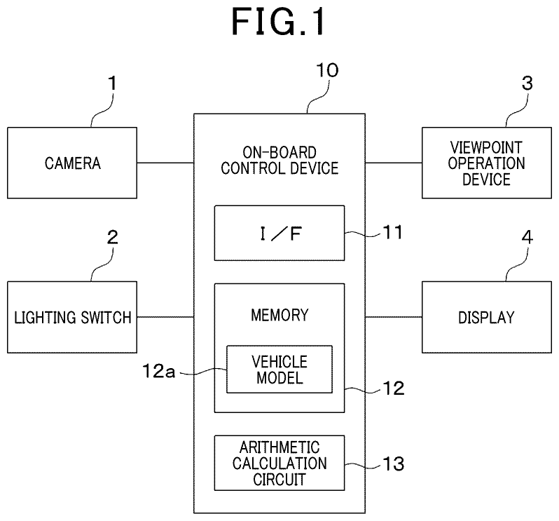

The following describes a first embodiment of the present disclosure. An on-board system according to this embodiment is mounted on a vehicle. As shown in FIG. 1, the on-board system is provided with at least one camera 1, a lighting switch 2, a viewpoint operation device 3, a display 4, and an on-board control device 10. The on-board control device 10 is an example of a display control device.

The at least one camera 1 is mounted at one or more locations of the vehicle. Herein after, it is described as the camera 1. The camera 1 captures images of the surroundings of the vehicle and sequentially outputs the captured images to the on-board control device 10. The lighting switch 2 is a switch for vehicle occupants (e.g., a driver) to operate the lighting and extinguishing of lighting equipment of the vehicle. An occupant operation of lighting switch 2 is referred to as a lighting operation.

The lighting equipment operable by lighting switch 2 include, for example, headlights, turn signals, taillights, brake lights, etc. The lighting switch 2 for operating the turn signal on and off is a direction indicator switch. Furthermore, the lighting switch 2 for operating the brake light on and off is a brake pedal.

The viewpoint operation device 3 is operated by a user (e.g., a driver or other occupant) to determine the viewpoint of a bird's-eye view image. The bird's-eye view image is an image displayed on a two-dimensional display screen, showing the vehicle (target vehicle) and its surroundings in a bird's-eye view from the set viewpoint. In the bird's-eye view image, the vehicle is represented in a 3D view using projection techniques such as central projection, so that it appears three-dimensional with a sense of perspective from the user's viewpoint.

The viewpoint operation device 3 may be a device such as a joystick, a touch panel placed on the display surface of the display 4, or a plurality of mechanical buttons. The viewpoint operation device 3 may also be a user camera that images hand gestures of the user (e.g., driver's), or a microphone that acquires voice of the user.

The display 4 is a device that displays images to the user corresponding to video signals output from the on-board control device 10. The display 4 displays the bird's-eye view image.

The on-board control device 10 identifies the viewpoint based on signals from the camera 1, the lighting switch 2, and the viewpoint operation device 3, etc. The on-board control device 10 generates the bird's-eye view image as seen from the identified viewpoint and causes the display 4 to draw the bird's-eye view image. The on-board control device 10 may also have other functions (e.g., autonomous driving function, navigation function, parking assist function). The on-board control device 10 includes an input/output interface circuit 11, a memory 12, an arithmetic calculation circuit 13, etc.

The input/output interface circuit 11 mediates signal exchange between external devices (i.e., the camera 1, the lighting switch 2, the viewpoint operation device 3, etc.) and the arithmetic calculation circuit 13. The input/output interface circuit 11 may perform this exchange via an in-vehicle LAN or via wired connections to each external device.

For example, the input/output interface circuit 11 may acquire a signal indicating that a viewpoint modification operation has been performed by a user on the viewpoint operation device 3, an imaged image from the camera 1, and a signal indicating that a user lighting operation has been performed on the lighting switch 2, and output them to the arithmetic calculation circuit 13.

The memory 12 includes non-volatile memory (e.g., ROM, flash memory) and volatile memory (e.g., RAM). The non-volatile memory stores a program read and executed by the arithmetic calculation circuit 13 and a vehicle model 12a. The volatile memory is used as a working area by the arithmetic calculation circuit 13 during processing. Each of the non-volatile memory and the volatile memory is a non-transitory physical storage medium.

The vehicle model 12a is three-dimensional model information containing data of the vehicle's three-dimensional structure. The vehicle model 12a includes polygon information such as the range occupied by each component (body, tires, lighting equipment, window glass, etc.) constituting the vehicle's exterior in three-dimensional space, along with color and brightness data.

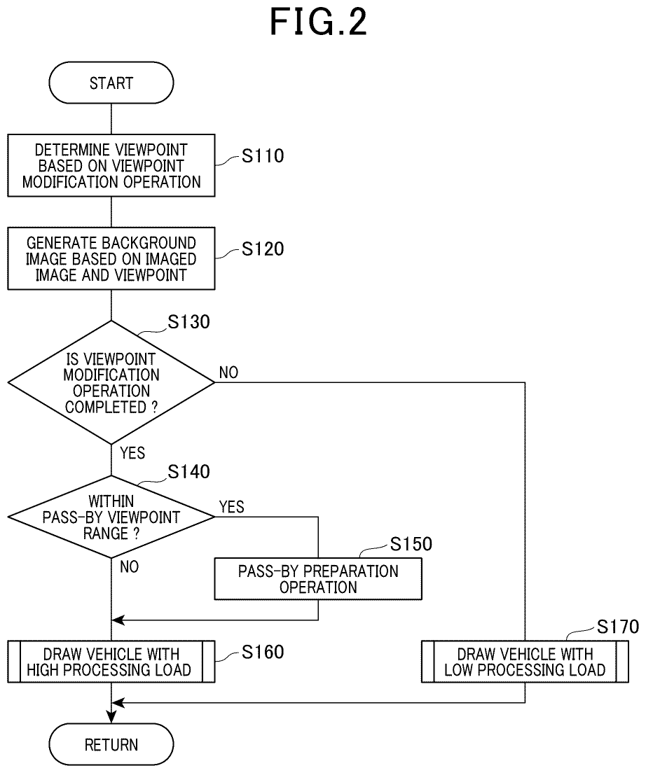

The following describes operations performed by the on-board system described above for prevention of the vehicle collision, and for assistance with the lateral movement and the passing-by. When the ignition of the vehicle is turned on and the user performs a predetermined start operation, the arithmetic calculation circuit 13 of the on-board control device 10 performs a drawing process to cause the display 4 to display the bird's-eye view image. The predetermined start operation may be a predetermined button operation or a predetermined vehicle driving operation (e.g., an operation to increase a steering angle of a steering wheel of the vehicle beyond a predetermined angle). Alternatively, the arithmetic calculation circuit 13 may perform the drawing process when the speed of the vehicle decreases to or below a predetermined speed. During the drawing process, when the user performs the viewpoint modification operation, the arithmetic calculation circuit 13 performs the process shown in FIG. 2. The drawing process and the process shown in FIG. 2 are realized by the arithmetic calculation circuit 13 executing a program read from the non-volatile memory.

As shown in FIG. 2, in step S110, the arithmetic calculation circuit 13 determines a viewpoint in accordance with the viewpoint modification operation. The viewpoint modification operation is an operation performed by the user using the viewpoint operation device 3 to change the viewpoint of the bird's-eye view image within three-dimensional space. The viewpoint modification operation may be an operation of tilting the joystick constituting the viewpoint operation device 3 in the direction to move the viewpoint. The viewpoint modification operation may also be a flick operation or a slide operation on the touch panel constituting the viewpoint operation device 3 in the direction to move the viewpoint.

The viewpoint modification operation may be performed by the user placing their hand in a position where the user camera constituting the viewpoint operation device 3 can capture it, and then performing a predetermined viewpoint movement gesture with their hand at that position. The viewpoint modification operation may be performed by the user issuing a voice command for viewpoint movement to the microphone constituting the viewpoint operation device 3. The viewpoint modification operation changes the direction from a predetermined reference point (e.g., the center point of the vehicle) to the viewpoint. The distance from the reference point to the viewpoint is set to a predetermined default distance.

In step S110, the arithmetic calculation circuit 13 acquires a signal corresponding to the viewpoint modification operation from the viewpoint operation device 3 via the input/output interface circuit 11 and determines the viewpoint in the three-dimensional space corresponding to the viewpoint modification operation.

In step S120, the arithmetic calculation circuit 13 generates a background image corresponding to the current viewpoint by performing processing such as compositing and viewpoint transformation on the imaged image of the surroundings of the vehicle acquired from the camera 1 via the input/output interface circuit 11. The background image corresponding to the current viewpoint is the image of the bird's-eye view image within a certain range around the vehicle as seen from the viewpoint. When performing the viewpoint transformation, all objects within the imaged image may be assumed to be located at a height of zero in the three-dimensional space (i.e., the road surface). The area under the vehicle in the background image (i.e., the portion obscured from the camera 1 by the vehicle itself as an obstacle) is composed of a single color, such as black. This background image is later composited with the vehicle image based on the vehicle model 12a.

In step S130, the arithmetic calculation circuit 13 determines whether a viewpoint modification operation has been completed. The viewpoint modification operation may be, for example, a single flick or drag operation on the touch panel when the viewpoint operation device 3 is a touch panel. Specifically, the arithmetic calculation circuit 13 may determine that the viewpoint modification operation has been completed when a predetermined time (e.g., 1 second) has elapsed since the last viewpoint modification operation was performed. This is because when no subsequent viewpoint modification operation is performed after the last viewpoint modification operation and a predetermined time elapse, it is considered that the user has finished the continuous viewpoint modification operation. Alternatively, the arithmetic calculation circuit 13 may determine that the viewpoint modification operation has been completed when a predetermined user operation indicating termination of the viewpoint modification operation is performed on the viewpoint operation device 3. When the arithmetic calculation circuit 13 determines that the continuous viewpoint modification operation has been completed, the process proceeds to step S140. When the arithmetic calculation circuit 13 determines that the continuous viewpoint modification operation has not been completed, (i.e., when it is determined that the viewpoint modification operation is still ongoing), the process proceeds to step S170.

In step S140, the arithmetic calculation circuit 13 determines whether the current viewpoint after the viewpoint modification operation completion is within a predetermined pass-by viewpoint range. The pass-by viewpoint range is a range of the viewpoint for checking the possibility of contact between the vehicle and an obstacle on its left or right side (e.g., an oncoming vehicle passing by, a pedestrian passing by, a utility pole) on a narrow road, or when intending to move laterally. The pass-by viewpoint range may be a range of the viewpoint located within a predetermined angle (e.g., 45°) relative to a reference direction. This reference direction extends from a reference position (e.g., the vehicle's center position) toward a direction behind and diagonally upward from the vehicle (e.g., diagonally upward at 45° relative to the ground).

When the modified viewpoint is within the pass-by viewpoint range, the process proceeds to step S150. When the modified viewpoint is outside the pass-by viewpoint range, the process skips step S150 and proceeds to step S160.

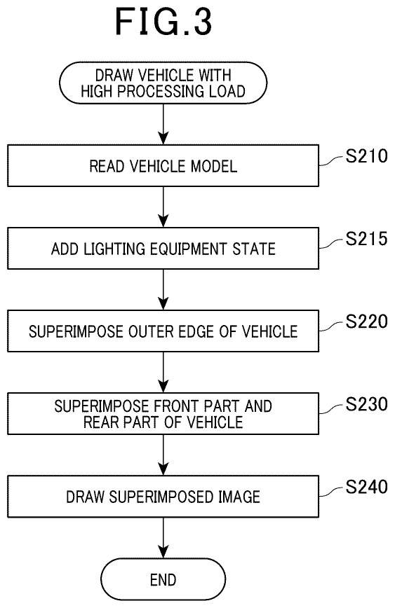

The arithmetic calculation circuit 13 performs the process shown in FIG. 3 as the process in step S160. As shown in FIG. 3, in step S210, the arithmetic calculation circuit 13 reads the vehicle model 12a from the memory 12. In step S215, the arithmetic calculation circuit 13 adds the current lighting equipment state information of the vehicle onto the read vehicle model 12a. Specifically, based on signals received from the lighting switch 2 via the input/output interface circuit 11, the arithmetic calculation circuit 13 determines whether the current lighting equipment is illuminated or not illuminated. In conjunction with this determined state, the arithmetic calculation circuit 13 sets the color of the lighting equipment within the vehicle model 12a to the pixel value (e.g., the brightness of each RGB component) corresponding to the detected illuminated or not illuminated state.

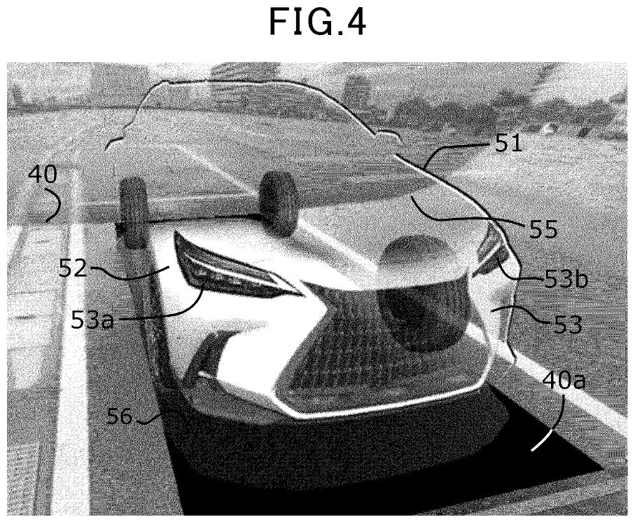

In step S220, the arithmetic calculation circuit 13 calculates the two-dimensional position coordinates of an outer edge of the vehicle in the bird's-eye view image viewed from the current viewpoint based on the read vehicle model 12a. Then, as shown in FIGS. 4 to 6, the arithmetic calculation circuit 13 superimposes an outer edge line 51, indicating the outer edge of the vehicle visible from the viewpoint, onto the background image 40 generated in step S120. The lines indicating this outer edge line 51 are superimposed onto the background image 40 as two adjacent lines of different colors. Using a high-contrast pair such as black and white for these two lines improves visibility. Alternatively, one of the colors for these two lines may be selected to provide high contrast against the body color of the vehicle in the vehicle model 12a.

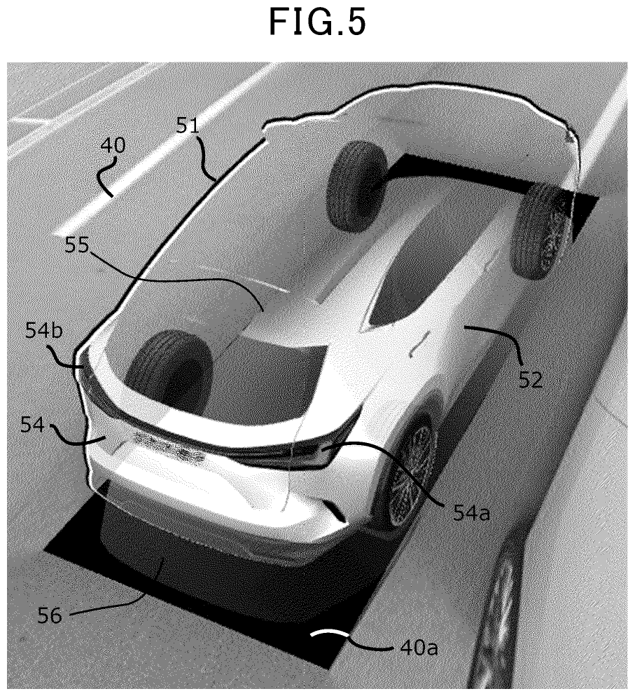

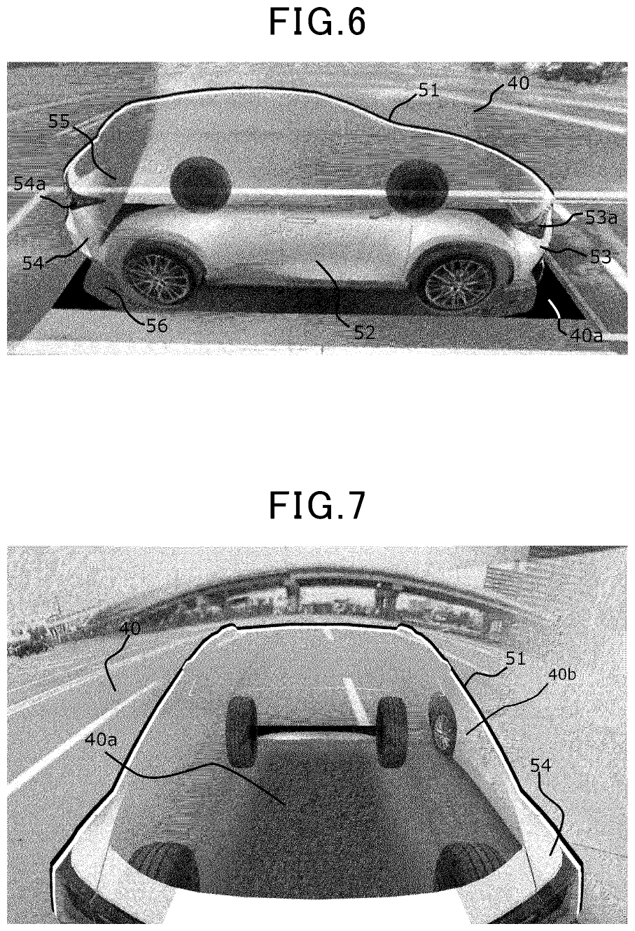

FIG. 4 shows an example of the bird's-eye view image displayed when the viewpoint is located diagonally above and right front of the vehicle. FIG. 5 shows an example of the bird's-eye view image displayed when the viewpoint is located diagonally above and right rear of the vehicle. FIG. 6 shows an example of the bird's-eye view image displayed when the viewpoint is located diagonally above and right side of the vehicle.

In step S230, the arithmetic calculation circuit 13 calculates, based on the vehicle model 12a, the two-dimensional position coordinates and pixel values of each part of the vehicle surface in the bird's-eye view image viewed from the current viewpoint. Then, as shown in FIG. 4, the arithmetic calculation circuit 13 superimposes the corresponding pixel values onto the bird's-eye view image, which is a composite of the background image 40 and the vehicle outline 51, for each two-dimensional position coordinate of each part of the vehicle surface. Only the portions of the vehicle surface visible from the viewpoint that is, portions without obstacles between the viewpoint and the surface are superimposed onto the background image 40. Hereinafter, the image superimposed onto the background image 40 based on the vehicle model 12a is referred to as a vehicle image.

When superimposing the vehicle image onto the background image 40, the transparency level with which the background image 40 allows the vehicle image for passing by is not uniform. Specifically, as shown in FIG. 4, the transparency level is set lower for the areas of the background image 40 where the underfloor area 40a overlaps with the vehicle image 52 and the area corresponding to the front of the vehicle 53 compared to the areas corresponding to other surfaces of the vehicle. In FIG. 5, the transparency level is set lower for the areas of the background image 40 where the underfloor area 40a overlaps with the vehicle image 52 and the area corresponding to the rear surface 54 compared to the areas corresponding to other surfaces of the vehicle. In FIG. 6, the transparency level is set lower for the areas of the background image 40 where the underfloor area 40a overlaps with the vehicle image 52, the area corresponding to the front of the vehicle 53 and the area corresponding to the rear surface 54 compared to the areas corresponding to other surfaces of the vehicle. The positions corresponding to the front surface 53 and rear surface 54 of the vehicle are predetermined and stored in the memory 12 as part of vehicle model 12a.

The transparency level of a pixel within the bird's-eye view image is an indicator showing the degree of compositing between the background image 40 and the vehicle image at that pixel. The lower the transparency level, the greater the influence of the vehicle image at that pixel and the smaller the influence of the background image 40. That is, the lower the transparency level, the darker the vehicle image appears and the lighter the background image 40 appears. When the transparency level at a pixel is the minimum value of zero, only the vehicle image is displayed at that pixel. When the transparency level is the maximum value of 100, only the background image 40 is displayed at that pixel.

Within the vehicle image, the transparency level of the portion 52 overlapping the underfloor area 40a, the front 53, and the rear 54 is set to a first transparency level, while the transparency level of the vehicle's other parts is set to a second transparency level. In the examples of FIGS. 4 to 6, the first transparency level is zero, and the second transparency level is 100. The values of the first and second transparency levels are not limited to these; they can be appropriately modified under the condition that the second transparency level is higher than the first.

When both the front 53 and the rear 54 of the vehicle are displayed, the first transparency level is applied regardless of whether they overlap the underfloor area 40a, do not overlap it, or overlap partially while other parts do not overlap. Even within the same first transparency level, the transparency level of the portion of the front 53 or the rear 54 that does not overlap with the underfloor area 40a may be set higher than the transparency level of the portion that overlaps with the underfloor area 40a.

As shown in FIG. 4, when the viewpoint relative to the longitudinal direction of the vehicle is located forward of the front end of the vehicle, the arithmetic calculation circuit 13 causes the front surface 53 to be displayed with the first transparency level and does not cause the rear surface 54 to be displayed. As shown in FIG. 5, when the viewpoint relative to the longitudinal direction of the vehicle is located rearward of the rear end of the vehicle, the arithmetic calculation circuit 13 causes the front surface 53 to be displayed with the second transparency level and does not cause the rear surface 54 to be displayed. As shown in FIG. 6, when the viewpoint relative to the longitudinal direction of the vehicle is between the front end and the rear end of the vehicle and the viewpoint is located laterally to the vehicle, the arithmetic calculation circuit 13 may cause both the front surface 53 and the rear surface 54 to be displayed with the first transparency level. Alternatively, as another example, the arithmetic calculation circuit 13 may cause both the front surface 53 and the rear surface 54 to be displayed with the second transparency level.

As shown in FIGS. 4 and 6, the front surface 53 to which the first transparency level is applied includes images of lighting equipment 53a and lighting equipment 53b. The lighting equipment 53a and the lighting equipment 53b include headlights, turn signals, etc. Furthermore, as shown in FIGS. 5 and 6, the rear surface 54 to which the first transparency level is applied includes images of lighting equipment 54a and lighting equipment 54b. The lighting equipment 54a and the lighting equipment 54b include tail lamps, brake lamps, turn signals, etc.

The pixel values of the images of the lighting equipment 53a, 53b, 54a, and 54b change in response to the actual lighting and extinguishing states of the lighting equipment of the vehicle, as described above. This allows the user to visually comprehend the lighting and extinguishing states of the lighting equipment 53a, 53b, 54a, and 54b by looking at the display 4. Since lighting equipment 53a, 53b, 54a, and 54b are displayed with the first transparency level which is relatively low, the user can easily comprehend their on/off states. The arithmetic calculation circuit 13 may cause the front surface 53 to be displayed with the first transparency level only when either the lighting equipment 53a or 53b is illuminated, and with the second transparency level when neither is illuminated. The arithmetic calculation circuit 13 may cause the rear surface 54 to be displayed with the first transmittance level only when either the lighting equipment 54a or 54b is illuminated, and with the second transmittance when neither is illuminated.

In the examples of FIGS. 4 to 6, within bird's-eye view image, a gradient range 55 is provided between the two-dimensional coordinate range where the first transparency level is applied and the two-dimensional coordinate range where the second transparency level is applied, wherein the transparency level gradually increases from the first transparency level to the second transparency level. Providing such a gradient range enhances the aesthetic appeal of the image.

As shown in FIGS. 4 to 6, the arithmetic calculation circuit 13 may also cause wheels and tires of the vehicle to be displayed with the first transparency level. Furthermore, as shown in FIGS. 4 to 6, the arithmetic calculation circuit 13 may cause a vehicle shape 56 projected onto the ground to be displayed within the underfloor area 40a based on vehicle model 12a, to make the outline of the vehicle easier to comprehend.

In step S240, the arithmetic calculation circuit 13 causes the display 4 to draw the bird's-eye view image generated by superimposing the outer edge and the vehicle image onto the background image. After step S240, the process of step S160 terminates. After step S160, the process returns again to step S110.

When it is determined in step S140 that the vehicle is within the pass-by viewpoint range and the process proceeds to step S150, the arithmetic calculation circuit 13 performs a pass-by preparation process in step S150. The arithmetic calculation circuit 13 lowers the height of the vehicle in the vehicle model 12a below the current height to enable a display suitable for passing-by. For example, the height at each position within vehicle model 12a may be set to one-tenth of the current height. This reduces the amount by which the vehicle protrudes from the underfloor area 40a within the bird's-eye view image by lowering the vehicle height in vehicle model 12a.

In a case that the pass-by preparation process is performed, as shown in FIG. 7, the outer edge line 51 of the vehicle protrudes significantly outside the underfloor area 40a in the bird's-eye view image. This makes it difficult for the user to determine whether the vehicle can pass-by obstacles on its left or right side (e.g., oncoming vehicles passing-by, pedestrians passing-by, utility poles) using the bird's-eye view image. For example, in FIG. 7, another vehicle 40b is displayed as part of the background image 40 on the right side of the vehicle. Although the vehicle and the other vehicle 40b are not actually in contact, in the bird's-eye view image, the other vehicle 40b intrudes significantly inside the outer edge line 51.

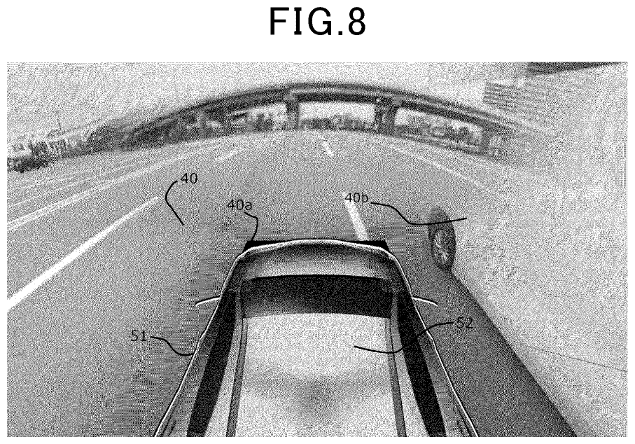

The process performed in step S160, performed after the pass-by preparation process in step S150, is the same as when proceeding to step S160 by skipping step S150. However, since the height of the vehicle model 12a has been reduced, as shown in FIG. 8, the vehicle image displayed in the bird's-eye view image also reflects this height reduction.

As shown in FIG. 8, the reduction in the height of vehicle model 12a results in a reduced amount by which the outer edge line 51 of the vehicle protrudes outside the underfloor area 40a. Consequently, the user can easily determine whether the vehicle can pass-by an obstacle (e.g., another vehicle 40b) on its left or right side using the bird's-eye view image.

When it is determined in step S130 that the viewpoint modification operation is not complete and process proceeds to step S170, the arithmetic calculation circuit 13 generates the bird's-eye view image with a lower processing load for generation than in step S160 and causes the display 4 to the draw bird's-eye view image.

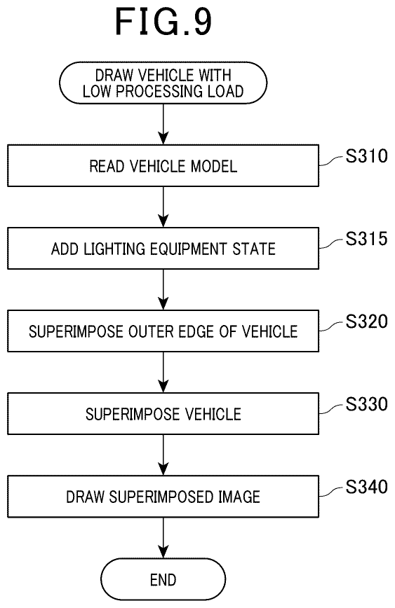

Specifically, the arithmetic calculation circuit 13 performs the process shown in FIG. 9 as step S170. In this process, in steps S310 and S315 the arithmetic calculation circuit 13 reads the vehicle model 12a from the memory 12, similar to steps S210 and S215 in FIG. 3, and adds the current lighting equipment state information of the vehicle onto the read vehicle model 12a. Next, in step S320, the arithmetic calculation circuit 13 superimposes the vehicle outline 51 onto the background image 40, similar to step S220 in FIG. 3.

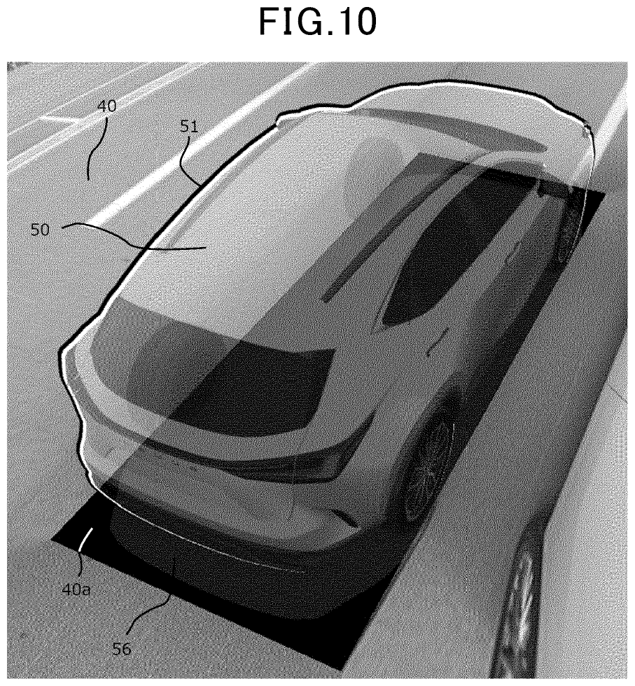

Next, in step S330, the arithmetic calculation circuit 13 calculates, based on the vehicle model 12a, the two-dimensional position coordinates and pixel values for each part of the vehicle surface in the bird's-eye view image from the current viewpoint. Then, as shown in FIG. 10, the arithmetic calculation circuit 13 superimposes the corresponding pixel values onto the bird's-eye view image containing the background image for each two-dimensional position coordinate of each part of the vehicle surface.

At this time, for all the vehicle image 50 superimposed onto the background image based on the vehicle model 12a, the transparency level of the vehicle image is uniform regardless of location, differing from the process in step S230 of FIG. 3. The transparency level may, for example, be uniformly zero, uniformly 10, or uniformly 50. By making the transparency level uniform regardless of location in this manner, the processing load on the arithmetic calculation circuit 13 is reduced compared to when it is not uniform.

Next, in step S340, the arithmetic calculation circuit 13, causes the display 4 to draw the bird's-eye view image generated by superimposing the outer edge and the vehicle image onto the background image. After step S340, the process of step S160 terminates. After step S160, the process returns again to step S110.

In the process of FIG. 9, the arithmetic calculation circuit 13 may omit the process of step S315 after step S310 and proceed to step S320. By this operation, it is possible to further reduce the processing load on the arithmetic calculation circuit 13.

[1] As described above, the arithmetic calculation circuit 13 of the on-board control device 10 determines the modified viewpoint for the vehicle based on the viewpoint modification operation, and based on the modified viewpoint, generates the bird's-eye view image viewed from the modified viewpoint using the imaged image and the vehicle model 12a. Then the arithmetic calculation circuit 13 causes the display 4 to display the bird's-eye view image.

In the bird's-eye view image, the vehicle image based on the vehicle model 12a overlaps the imaged image. The arithmetic calculation circuit 13 sets the transparency level of the imaged image through the vehicle image to the first transparency level in one portion of the overlapping area and sets the transparency level of the imaged image through the vehicle image to the second transparency level which is higher than the first transparency in the other portion.

The arithmetic calculation circuit 13 varies the range of two-dimensional position coordinates occupied by the portion in which the first transparency level is applied and the portion in which the second transparency level is applied within the bird's-eye view image according to the modified viewpoint.

As a result, in the technology for displaying a vehicle and its surroundings from a bird's-eye view, it is possible to vary the bird's-eye view image more flexibly.

[2] When lighting equipment overlaps with the imaged image in the bird's-eye view image, the arithmetic calculation circuit 13 sets the first transparency level to the portion of the vehicle image containing lighting equipment and simultaneously turns lighting equipment in the bird's-eye view image on and off in synchronization with the lighting operation. This makes the synchronized on/off display of lighting equipment in the bird's-eye view image easier to be comprehend.

[3] The arithmetic calculation circuit 13 reduces the height of vehicle model 12a when the modified viewpoint is within the predetermined pass-by viewpoint range than when it is outside this range. This reduces the possibility of the vehicle image extending outside the underfloor area of the vehicle in the bird's-eye view image. Consequently, it facilitates pass-by judgement of the occupant.

[4] The arithmetic calculation circuit 13 determines whether the viewpoint modification operation is ongoing. While the viewpoint modification operation is ongoing, the arithmetic calculation circuit 13 reduces the processing load for generating the bird's-eye view image compared to when the viewpoint modification operation is not ongoing. By this, it is possible to suppress the processing load when the display content changes relatively abruptly during the viewpoint modification while enhancing the expressiveness of the image after the viewpoint modification operation ends. Consequently, it achieves a balanced realization of both reduced processing load and improved visibility.

In this embodiment, the arithmetic calculation circuit 13 functions as a position determination unit by executing step S110 in FIG. 2, and functions as a drawing unit by executing steps S120, S130, S140, S150, S160, and S170.

### Second Embodiment

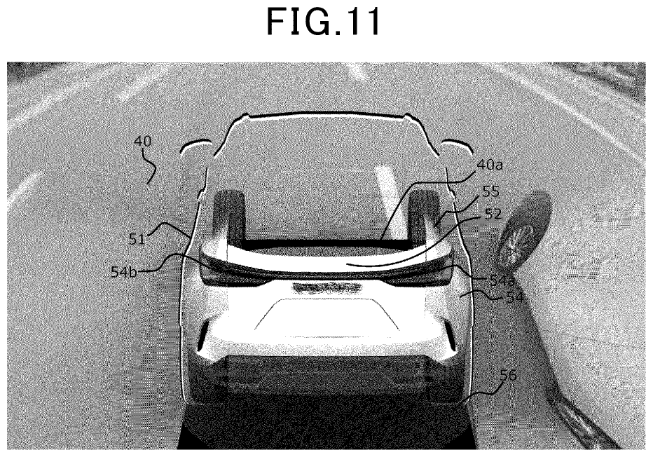

The second embodiment is described using FIG. 11. Compared to the first embodiment, the content of the pass-by preparation process in step S150 differs in this embodiment. Specifically, the arithmetic calculation circuit 13 moves the viewpoint determined in step S110 away from the vehicle. At this time, the arithmetic calculation circuit 13 maintains the viewpoint within the slippage viewpoint range. For example, the arithmetic calculation circuit 13 increases the distance from the reference point determined in step S110 (e.g., the center of the vehicle) to the viewpoint (i.e., the default distance) while maintaining the direction from the reference point determined in step S110 to the viewpoint. The degree of distance increase may be, for example, five times the default distance or ten times the default distance.

The process performed in step S160, performed after the pass-by preparation process in step S150, is the same as when proceeding to step S160 by skipping step S150. However, as described above, since the viewpoint has moved farther away, the vehicle image displayed on the bird's-eye view image, as shown in FIG. 10, also takes a form corresponding to the more distant viewpoint.

As shown in FIG. 10, the result of the viewpoint moving farther away reduces the amount by which the outer edge line 51 of the vehicle protrude outside the underfloor area 40a. Consequently, it becomes easier for the user to determine whether the vehicle can pass-by obstacles on its left or right side using the bird's-eye view image.

When the viewpoint moves from within the pass-by viewpoint range to outside it, the process unit 13 proceeds to step S160 after performing the process of step S140. Therefore, the distance from the reference point to the viewpoint remains as determined in step S110. This also applies when proceeding from step S130 to step S170. In step S150 of this embodiment, the viewpoint may be moved farther away, and the height of the vehicle model 12a may or may not be reduced. Other configurations and operations are the same as in the first embodiment. Similar effects can be obtained from the same configurations in this embodiment and the first embodiment.

### Third Embodiment

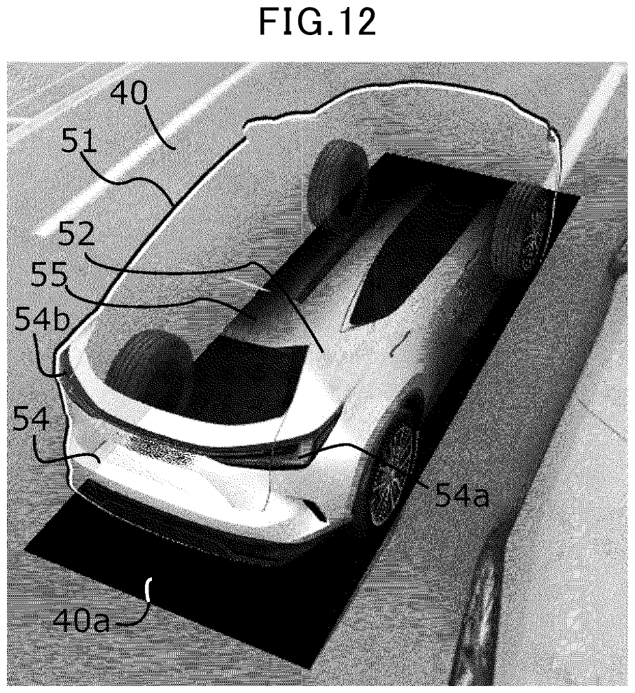

The third embodiment is described using FIG. 12. In this embodiment, compared to the first and second embodiments, the vehicle shape 56 projected onto the ground within the underfloor area 40a is omitted from the bird's-eye view image generated by the arithmetic calculation circuit 13. Even with this omission, the same effects as in the first and second embodiments are achieved for configurations other than the vehicle shape 56.

### Fourth Embodiment

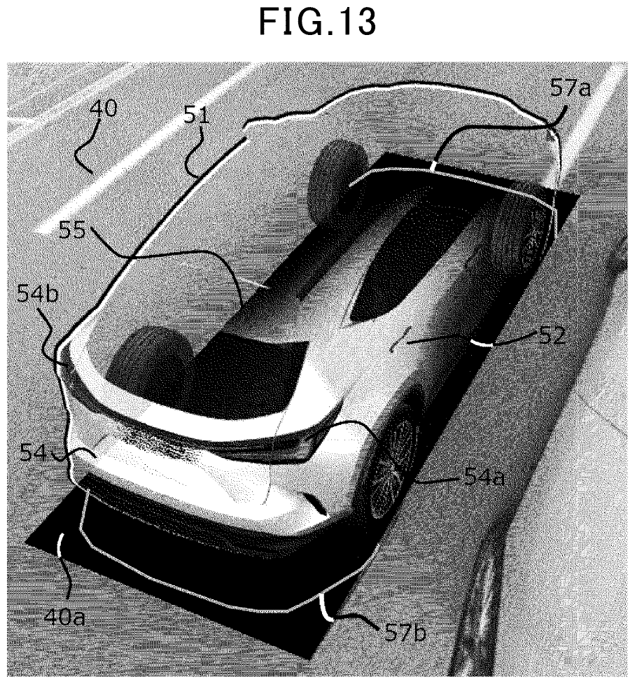

Next, the fourth embodiment is described with reference to FIG. 13. In this embodiment, compared to the first and second embodiments, the vehicle shape 56 projected onto the ground within the underfloor area 40a is omitted from the bird's-eye view image generated by the arithmetic calculation circuit 13. Furthermore, in this embodiment, vehicle outline lines 57a and 57b are added to the bird's-eye view image generated by the arithmetic calculation circuit 13. The vehicle outline lines 57a and 57b are lines indicating the outer boundary of the vehicle shape projected onto the ground within the underfloor area 40a.

This achieves the same effect as the vehicle shape 56 in the first and second embodiments. Other configurations and operations are the same as in the first embodiment. Similar effects are obtained from the same configurations in this embodiment and the first and second embodiments.

### Fifth Embodiment

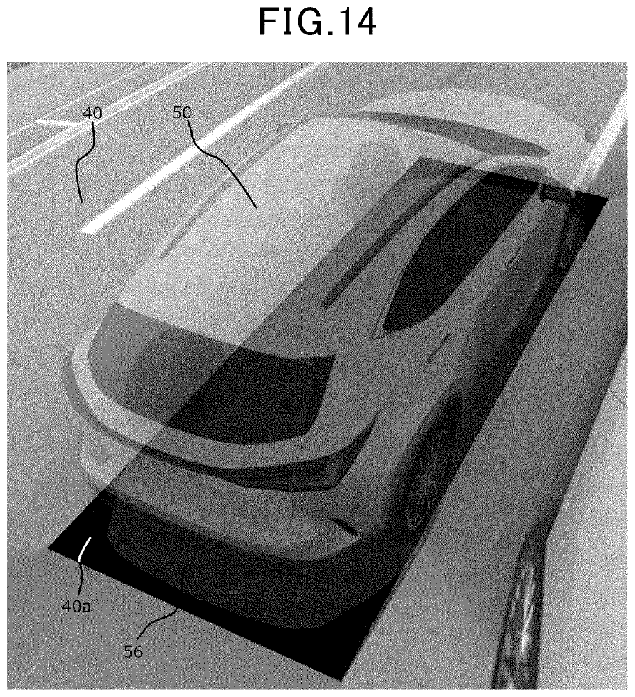

Next, the fifth embodiment is described using FIG. 14. Compared to the first to fourth embodiments, in this embodiment, the arithmetic calculation circuit 13 omits step S320 in the process of FIG. 9.

Specifically, in the process of FIG. 9, the arithmetic calculation circuit 13 skips the process of step S320 after step S310 or step S315 and proceeds to step S330. As a result, the bird's-eye view image without the outer border line 51, as shown in FIG. 14, is displayed on the display 4. By this, the process load on the arithmetic calculation circuit 13 is further reduced by the amount of processing omitted for the outer border line 51.

### Another Embodiments

The present disclosure is not limited to the above embodiments and may be modified as appropriate. Furthermore, the above embodiments are not mutually exclusive and may be combined as appropriate, except where such combination is clearly impossible. Furthermore, in each of the above embodiments, the elements constituting the embodiments are not necessarily essential, except where explicitly stated as essential or where they are clearly essential by principle. Also, in each of the above embodiments, when numerical values such as the number, quantity, amount, or range of components of the embodiment are mentioned, they are not limited to the specified number, except where explicitly stated as essential or where they are clearly limited to a specific number by principle. Furthermore, in the above embodiments, where it is described that external environment information of the vehicle is acquired from a sensor, it is possible to omit that sensor and instead receive the external environment information from a server or cloud outside the vehicle. Alternatively, it is possible to omit that sensor and instead acquire related information associated with the external environment information from a server or cloud outside the vehicle and estimate the external environment information from the acquired related information. In particular, when multiple values are exemplified for a certain quantity, it is possible to adopt a value between those multiple values, unless specifically stated otherwise or unless it is clearly impossible in principle. Furthermore, in each of the above embodiments, when referring to the shape, positional relationship, etc., of components, etc., it is not limited to that shape, positional relationship, etc., unless specifically stated or unless it is limited to a specific shape, positional relationship, etc., in principle. Furthermore, the present disclosure permits the following modifications and modifications within the scope of equivalents to the above embodiments. Note that the following modifications can be applied to or omitted from the above embodiments independently. That is, any combination of the following modifications can be applied to the above embodiments.

Furthermore, the arithmetic calculation circuit 13 and its method described herein may be implemented by a dedicated computer provided by configuring a processor and memory programmed to execute one or more functions embodied by a computer program. Alternatively, the arithmetic calculation circuit 13 and its method described herein may be implemented by a dedicated computer provided by configuring a processor comprising one or more dedicated hardware logic circuits. Alternatively, the arithmetic calculation circuit 13 and its method described herein may be implemented by one or more dedicated computers configured by a combination of a processor and memory programmed to execute one or more functions, and one or more hardware logic circuits. Furthermore, the computer program may be stored on a computer-readable, non-transitory physical storage medium as instructions executable by a computer.

### Modified Example 1

In the above embodiment, the entire on-board system is mounted to the vehicle. However, part of the on-board system may be installed at a remote location outside the vehicle. For example, in a case that the on-board control device 10 is not mounted to the vehicle but is installed at the remote location, the display 4, the viewpoint operation device 3, and the user operating them may also be located at the remote location away from the vehicle.

### Modified Example 2

In the above embodiment, the colors of the two lines constituting the outer edge line 51 may change according to the time of day. For example, black and white may be used for times corresponding to daytime, and black and pink may be used for times corresponding to nighttime.

### (Various Aspects)

### [Aspect 1]

A display control device for a vehicle comprising:
an interface circuit configured to acquire a viewpoint modification operation by a user for a viewpoint operation device and an imaged image from a camera imaging surrounding of the vehicle;
a memory storing a vehicle model that is a three-dimensional model of the vehicle,
an arithmetic calculation circuit configured to:
   determine the modified viewpoint for the vehicle based on the viewpoint modification operation;
   generate a bird's-eye view image from the determined modified viewpoint based on the imaged image and a vehicle image, the vehicle image being generated based on the vehicle model; and
   cause a display to display the generated bird's-eye view image,
wherein the arithmetic calculation circuit sets a first transparency level for the portion of the imaged image where the vehicle image overlaps to allow the imaged image to be transparent in the vehicle image in one part, sets a second transparency level which is higher than the first transparency level for the portion where the vehicle image overlaps to allow the imaged image to be transparent in the vehicle image in the other part, and changes, according to the modified viewpoint, range of each of the portion in which the first transparency level is applied and the portion in which the second transparency level is applied in two-dimensional position coordinates of the bird's-eye view image.

### [Aspect 2]

The display control device according to Aspect 1, wherein
the interface circuit is configured to acquire an information of lighting operation to the lighting switch performed by a user for the lighting and extinguishing of the lighting equipment, and
the arithmetic calculation circuit applies the first transparency level to the portion of the vehicle image containing the lighting equipment when the lighting equipment overlaps with the imaged image in the bird's-eye view image and turns the lighting equipment in the bird's-eye view image on and off in accordance with the lighting operation.

### [Aspect 3]

The display control device according to Aspect 2, wherein
the portion of the vehicle image containing the lighting equipment is a front part or a rear part of the vehicle.

### [Aspect 4]

The display control device according to Aspect 1, wherein
the arithmetic calculation circuit lowers the height of the vehicle in the vehicle model when the modified viewpoint is within a predetermined pass-by viewpoint range than when the modified viewpoint is outside the pass-by viewpoint range.

### [Aspect 5]

The display control device according to Aspect 1, wherein
the arithmetic calculation circuit moves the modified viewpoint farther away from the vehicle model when the modified viewpoint is within a predetermined pass-by viewpoint range than when the modified viewpoint is outside the pass-by viewpoint range.

[Aspect 6]

The display control device according to Aspect 1, wherein
the arithmetic calculation circuit determines whether the viewpoint modification operation is being performed, and
when determined that the viewpoint modification operation is being performed, the arithmetic calculation circuit reduces processing load for configuring the bird's-eye view image more than when determined that the viewpoint modification operation is not being performed.

### [Aspect 7]

A program executed in a display control device for a vehicle,
wherein the program is configured to cause the display control device to:
determine a modified viewpoint for the vehicle based on a viewpoint modification operation by a user for the viewpoint operation device;
acquire an imaged image from a camera imaging surrounding of the vehicle;
generate a bird's-eye view image from the determined modified viewpoint based on the imaged image and a vehicle image, the vehicle image being generated based on the vehicle model; and
cause a display to display the generated bird's-eye view image,
wherein the generation of the bird's-eye view image includes setting a first transparency level for the portion of the imaged image where the vehicle image overlaps to allow the imaged image to be transparent in the vehicle image in one part, setting a second transparency level which is higher than the first transparency level for the portion where the vehicle image overlaps to allow the imaged image to be transparent in the vehicle image in the other part, and changing, according to the modified viewpoint, range of each of the portion in which the first transparency level is applied and the portion in which the second transparency level is applied in two-dimensional position coordinates of the bird's-eye view image.

What is claimed is:

1. A display control device for a vehicle comprising:
an interface circuit configured to acquire a viewpoint modification operation by a user for a viewpoint operation device and an imaged image from a camera imaging surrounding of the vehicle;
a memory storing a vehicle model that is a three-dimensional model of the vehicle,
an arithmetic calculation circuit configured to:
determine the modified viewpoint for the vehicle based on the viewpoint modification operation;
generate a bird's-eye view image from the determined modified viewpoint based on the imaged image and a vehicle image, the vehicle image being generated based on the vehicle model; and
cause a display to display the generated bird's-eye view image,
wherein the arithmetic calculation circuit sets a first transparency level for the portion of the imaged image where the vehicle image overlaps to allow the imaged image to be transparent in the vehicle image in one part, sets a second transparency level which is higher than the first transparency level for the portion where the vehicle image overlaps to allow the imaged image to be transparent in the vehicle image in the other part, and changes, according to the modified viewpoint, range of each of the portion in which the first transparency level is applied and the portion in which the second transparency level is applied in two-dimensional position coordinates of the bird's-eye view image.

2. The display control device according to claim 1, wherein
the arithmetic calculation circuit is configured to:
when the modified viewpoint is at a first point, sets the first transparency level for the portion of the imaged image where the vehicle image overlaps to allow the imaged image to be transparent in the vehicle image in a first part, sets the second transparency level for the portion where the vehicle image overlaps to allow the imaged image to be transparent in the vehicle image in a second part different from the first part; and
when the modified viewpoint is at a second point different from the first point, sets the second transparency level for the portion of the imaged image where the vehicle image overlaps to allow the imaged image to be transparent in the vehicle image in the first part, sets the first transparency level for the portion where the vehicle image overlaps to allow the imaged image to be transparent in the vehicle image in the second part.

3. The display control device according to claim 2, wherein
the arithmetic calculation circuit is configured to:
when the modified viewpoint is at the first point and the first part is nearer to the first point than the second part, sets the first transparency level for the portion of the imaged image where the vehicle image overlaps to allow the imaged image to be transparent in the vehicle image in the first part, sets the second transparency level for the portion where the vehicle image overlaps to allow the imaged image to be transparent in the vehicle image in the second part; and
when the modified viewpoint is at the second point and the second part is nearer to the second point than the first part, sets the second transparency level for the portion of the imaged image where the vehicle image overlaps to allow the imaged image to be transparent in the vehicle image in the first part, sets the first transparency level for the portion where the vehicle image overlaps to allow the imaged image to be transparent in the vehicle image in the second part.

4. The display control device according to claim 3, wherein
the first part is a front part of the vehicle, and the second part is a rear part of the vehicle.

5. The display control device according to claim 1, wherein
the arithmetic calculation circuit is configured to add a vehicle outline visible from the modified viewpoint onto the bird's eye view image.

6. The display control device according to claim 1, wherein
the interface circuit is configured to acquire an information of lighting operation to the lighting switch performed by a user for the lighting and extinguishing of the lighting equipment, and
the arithmetic calculation circuit applies the first transparency level to the portion of the vehicle image containing the lighting equipment when the lighting equipment overlaps with the imaged image in the bird's-eye view image and turns the lighting equipment in the bird's-eye view image on and off in accordance with the lighting operation.

7. The display control device according to claim 6, wherein
the portion of the vehicle image containing the lighting equipment is a front part or a rear part of the vehicle.

8. The display control device according to claim 1, wherein
the arithmetic calculation circuit lowers the height of the vehicle in the vehicle model more when the modified viewpoint is within a predetermined pass-by viewpoint range than when the modified viewpoint is outside the pass-by viewpoint range.

9. The display control device according to claim 1, wherein
the arithmetic calculation circuit moves the modified viewpoint farther away from the vehicle model when the modified viewpoint is within a predetermined pass-by viewpoint range than when the modified viewpoint is outside the pass-by viewpoint range.

10. The display control device according to claim 1, wherein
the arithmetic calculation circuit determines whether the viewpoint modification operation is being performed, and
when determined that the viewpoint modification operation is being performed, the arithmetic calculation circuit reduces processing load for configuring the bird's-eye view image more than when determined that the viewpoint modification operation is not being performed.

11. A non-transitory computer readable storage medium storing a program executed in a display control device for a vehicle,
wherein the program is configured to cause the display control device to:
determine a modified viewpoint for the vehicle based on a viewpoint modification operation by a user for the viewpoint operation device;
acquire an imaged image from a camera imaging surrounding of the vehicle;
generate a bird's-eye view image from the determined modified viewpoint based on the imaged image and a vehicle image, the vehicle image being generated based on the vehicle model; and
cause a display to display the generated bird's-eye view image,
wherein the generation of the bird's-eye view image includes setting a first transparency level for the portion of the imaged image where the vehicle image overlaps to allow the imaged image to be transparent in the vehicle image in one part, setting a second transparency level which is higher than the first transparency level for the portion where the vehicle image overlaps to allow the imaged image to be transparent in the vehicle image in the other part, and changing, according to the modified viewpoint, range of each of the portion in which the first transparency level is applied and the portion in which the second transparency level is applied in two-dimensional position coordinates of the bird's-eye view image.
